(19) United States
(12) Patent Application Publication
(10) Pub. No.: US 2008/0272928 A1
(43) Pub. Date: Nov. 6, 2008

(54) SIGNALING LIGHT WITH MOTION-SENSING LIGHT CONTROL CIRCUIT

(76) Inventor: Gary S. Shuster, Fresno, CA (US)

Correspondence Address: CONNOLLY BOVE LODGE & HUTZ LLP, P.O. BOX 2207, WILMINGTON, DE, 19899, US

(21) Appl. No.: 11/743,850

(22) Filed: May 3, 2007

(51) Int. Cl. G08B 5/36

(52) U.S. Cl. 340/815.75

(57) ABSTRACT

A signaling light, such as a wand light or flashlight, includes a motion sensor coupled to a controller for lamp intensity. When the light is moved in a first direction, the lamp is powered at a baseline intensity. When the light is moved in a second direction generally opposite the first direction, the lamp is switched off or dimmed. When swung in a back-and-forth motion, the light as controlled by the controller thereby appears to move in only one direction, thereby providing a signal indicating a direction of motion.

### BACKGROUND

1. Field

The present disclosure relates to portable lights or wands such as are used in signaling traffic or other applications.

2. Description of Related Art

A major use of flashlight signaling devices is for directing traffic, such as automobile and pedestrian traffic. Often, persons directing traffic need a handheld light that can be used to signal pedestrians, passenger vehicles, and commercial vehicles to move in a desired direction. Current hand signaling lights are designed to emit light at a constant intensity regardless of how the light is being moved. When a light is being moved back-and-forth to direct traffic flow, the people being directed see the light moving back and forth, and cannot see or understand the signaled directional flow. This may lead to confusion and misdirection.

At the same time, swinging a light back-and-forth or from side-to-side is a highly effective signaling technique, because the swinging motion makes the swinging light stand out quite noticeably from a background. However, the swinging motion cannot effectively convey a direction of motion. Various flashlight or handheld signaling devices are known for directional signaling, but none are able to exploit a swinging motion to provide a directional signal. Directional signaling lights are known that use lighted arrows or moving light arrays, but such lights are not well-suited for portable use, nor do they make use of a natural swinging motion.

Therefore, a portable signaling device is needed for use by traffic officials and other individuals for directional signaling of traffic, utilizing a natural swinging motion. The present invention fulfills these needs and provides further related advantages as described in the following summary.

### SUMMARY

The present invention is directed to a portable light coupled to a motion sensor and controller that dims or shuts of the light depending on the direction of motion of the light. For example, when the light is swung in a first direction the light illuminates, then turns off or dims when swung in a different direction opposite to the first direction.

In one variation, a portable light comprises a housing configured for holding a light and a portable power source and an electrical circuit coupled to the housing. The housing may be configured as a conventional flashlight or lantern, or any other configuration suitable for grasping by hand. The electrical circuit may be configured for sensing motion of the housing and causing the light to illuminate at a first intensify in response to movement of the housing in a first direction, and for causing the light to switch off, or to illuminate at a second intensity that is visibly less than the first intensity, in response to movement of the housing in a second direction opposite to the first direction. In the alternative, illumination from the light may be controlled using a shutter mechanism, alternately blocking and transmitting light under the control of the electrical circuit. The housing may also include a manual on/off switch to turn the motion-sensing and control circuit off and on. When this switch is off, the light may be deactivated.

Optionally, the portable light may be configured to operate as a conventional flashlight or light wand. In this case, the housing may include a manual override switch or user input device. When the manual override is activated, the motion-sensing and light control circuit may be deactivated, while the light may still be manually controlled via a manual on/off switch, in the alternative, the housing may include a manual activation switch or user input that must be activated to activate the motion-sensing and light control circuit; if the circuit is not manually activated, it will be normally deactivated, in these embodiments, the housing may also include a manual on/off or dimmer control to control the light intensify manually when the motion-sensing light control circuit is deactivated.

The portable light may include various additional elements and features. For example, the portable light may include an electrical circuit for switching off the lighting element after no motion of the flashlight housing is detected for a defined period of time. For further example, the portable light may be fitted with an infrared beam to be used in military application where signaling is desired in conjunction with infrared technologies. Still further, the portable flashlight may be fitted with a laser to be used in military applications where laser Signaling is desired such as with remote control devices. Other additional options may include various lenses of any color or of more than one color. Further, a lens for the portable light may be of plastic, glass, or other polymer composition and may be constructed in such a manner as to provide a variety of focuses. The portable flashlight may be fit with an adjustable reflector for allowing a variety of light patterns and focal lengths, and may include more than one lamp controlled by the motion-sensing and control circuit.

A more complete understanding of the portable light with motion-sensing and light control circuit, and a method for use for it, will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a schematic of an exemplary portable light with a motion-sensing light control circuit, configured as a flashlight.

FIG. 2 is a schematic of an exemplary portable light with a motion-sensing light control circuit, configured as a light wand.

FIG. 3 is a perspective view of an exemplary portable light with a motion-sensing light control circuit, configured as a light wand with a domed diffuser.

FIG. 4 is a perspective view of an exemplary portable light with a motion-sensing light control circuit, configured as a light wand with an arrow-shaped diffuser.

FIG. 5 is a block diagram of an exemplary electrical circuit configured to sense motion of a portable signaling light and control light output.

FIG. 6 is a flowchart showing the operational characteristics of an exemplary portable light with a motion-sensing light control circuit.

FIG. 7 is a flowchart showing exemplary steps of a method for directing traffic using a portable light with a motion-sensing light control circuit.

FIG. 8 is a pictorial diagram illustrating an exemplary use of the signaling light to indicate a direction of movement.

FIG. 9 is a schematic diagram showing a shutter-operated signaling light,

In the detailed description that follows, like element numerals are used to indicate like elements appearing in one or more of the drawings.

### DETAILED DESCRIPTION OF VARIOUS EMBODIMENTS

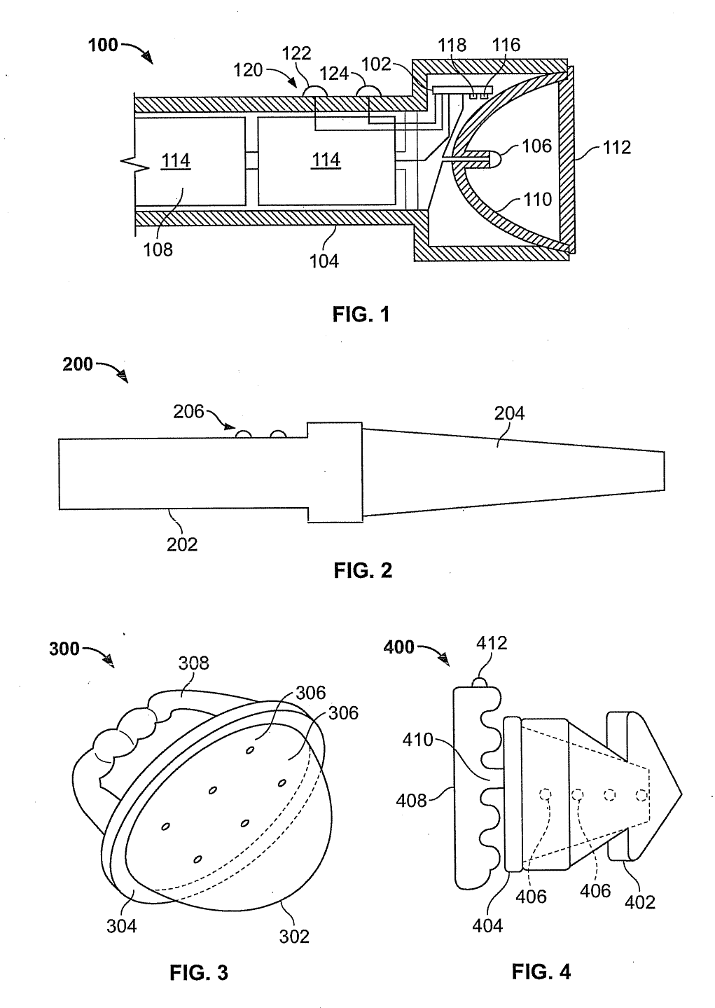

FIG. 1 shows an exemplary portable light 100 with a motion-sensing fight control circuit 102 coupled to a portable housing 104. Light 100 is configured as a flashlight, but may equally well be configured as a lantern, light wand, or other configuration suitable for grasping with one hand. Portable light 100 may include a housing 104 containing a light element 106 and a portable power source 108. The housing 104 may comprise a plastic material, a glass or carbon fiber composite material, a metal material, or any suitable combination of these or other suitable materials. It may be configured for grasping by hand, or may include a separate handle. The lighting element 106 may comprise an LED lamp, incandescent lamp, infrared lamp, fluorescent lamp, halogen lamp, or laser. A reflector 110 may be used to reflect light in one or more desired directions, to focus light into a beam, or both. The portable light 100 may further compose a transparent or translucent cover 112. The cover 112 may be configured as a protective covering for the lighting element 106. In addition, or in the alternative, the cover may be configured as a refractive lens for focusing, diffusing or refracting light from the lighting element.

The portable power source 108 may be adapted to receive a plurality of power cells 114 such as batteries in the interior thereof. As known in the ad, the power cells 114 may be connected in serial or parallel to provide various power arrangements. In the alternative, or in addition, the power source 108 may comprise a miniature dynamo or electrical generator for generating electrical power from mechanical energy. The light 100 is intended for use as a signaling device that is usually in motion, and so abundant mechanical energy should be available. Various suitable dynamos and generators for powering flashlights arts known in the art, and may be used to power the portable light 100.

The motion-sensing light control circuit 102 coupled to the portable housing 104 may comprise a controller 116 and a motion sensor 118. The motion sensor may be configured, for example, as a 3-axis accelerometer. Such sensors should be readily available as relatively inexpensive devices. Other types of motion sensors may also be suitable. Whatever type of sensor 118 is used, it should be capable of providing a reliable signal indicating a reversal of motion of the housing, such as may be indicated by deceleration in a first direction, immediately followed by an acceleration in a direction roughly parallel but opposite to the first direction. The controller 116 may be coupled to the motion sensor and configured to detected reversal of motion events. These events may then be used as input in a control process for controlling an illumination sequence for the portable light's lighting element 106. Controller 116 may comprise any suitable processor or microprocessor, such as a programmable logic controller.

Controller 116 may receive other inputs, for example user inputs from a suitable user interface 120, comprising control buttons 122, 124. A user interface may also, or in the alternative, comprise one or more knobs, sliders, membrane switches, keys, dials, or other control elements. The control buttons may be connected to inputs of controller 116 or otherwise operably associated with the control circuit 102. Various functions may be associated with the control elements. For example, control button 122 may be used as a simple on/off switch for circuit 102 and portable light 100. Control button 124 may be used to disable/enable the motion sensing and control functions of circuit 102. A third control element (not shown) may be used to adjust the phase of the illumination cycle during operation of the motion sensing light control circuit. In other words, an input may be provided to allow an operator to adjust the time or conditions at which the control circuit turns the lighting element 106 on or off.

The housing and light cover of a suitable portable light for directional signaling may take a wide variety of forms, a few examples of which are provided in FIGS. 2-4. FIG. 2 shows a light wand 200 comprising a graspable housing coupled to a diffusive translucent light cover 204. When illuminated by a lamp shining from the end of the housing, the light cover becomes a glowing object that is readily visible at night from any direction. The light wand 200 may also include control buttons 206 and other features as previously described. When waved in sync with illumination of the light cover, the light wand can be used to provide a directional traffic signal. Synchronization with an on/off illumination cycle can be achieved using a motion sensing and control circuit as described herein.

FIG. 3 shows an alternative signaling assembly 300 comprising a domed translucent diffusive cover 302 attached to a light bar base 304. Multiple low-power lamps, such as LED's 306, are attached to the base 304 and configured to illuminate the cover 302. The base is attached to a handle 308 configured for grasping in one hand. Control and power elements such as previously described may be contained in the light bar, handle, or both.

FIG. 4 shows an alternative signaling assembly 400 comprising a translucent diffusive light cover 402 formed in the shape of a directional arrow. The light cover, when illuminated by lamps 406 in the light bar base 404, becomes a glowing arrow suitable for directional signaling. The base 404 may be attached to a graspable handle using one or mom supports 410. One or more supports 410 may be configured to pass between fingers of a users hand. Control and power elements such as previously described may be contained in the light bar base 404, handle 408, or both. Handle 408 may include one or more control buttons 412, which may be positioned on a surface of the handle or fight bar away from areas configured for grasping.

The signaling assembly 400 may further comprise motion sensing and illumination control circuitry as described herein. When waved or swung back and forth, the arrow may be illuminated only while the assembly 400 is moving in the direction indicated by the directional arrow formed in the light cover. The movement of the illuminated assembly thereby enhances the directional signal provided by the shape of the light cover.

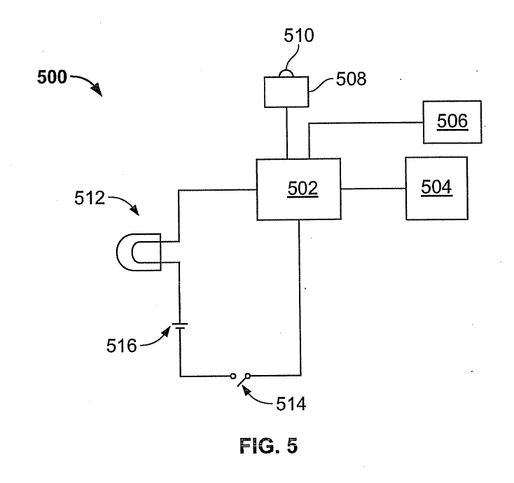

FIG. 5 shows an exemplary electrical circuit 500 configured to sense motion of a portable signaling light as described herein and control light output. Circuit 500 may comprise a controller 502, such as a programmable logic controller, coupled to a motion sensor 504. The controller may include a memory for storing executable code or other data, or may be couple to a separate memory device (not shown). The circuit may include a power switch 514, a power source 516 and a lighting element 512. The circuit 500 may include other elements that should be apparent to one of ordinary skill, for example, power and signal conditioning elements, connectors, and so forth.

A timer 506 may also be coupled to the controller. Features and functions of the motion sensor for motion-related light control have been described above. The timer 506 may be used to keep track of periods of Inactivity (no movement). Circuit 500 may be configured to automatically power off the signaling light after determining, using signals from the motion sensor 504 and the timer 506, that the circuit has not been moved for a period of time. In addition, or in the alternative, the timer 506 may be used to allow time-based light control independently of movement of the signal light assembly. For example, the timer and controller may cause the lighting element 512 to blink on and off at constant intervals of one second.

A user Interface module 508 comprising one or more user input elements 510 may also be coupled to the controller. Various alternative user inputs are described above. Depending on signals from the user Interface 508, the controller 502 may alter how the lighting element 512 is controlled in response to other signals, such as from motion sensor 504.

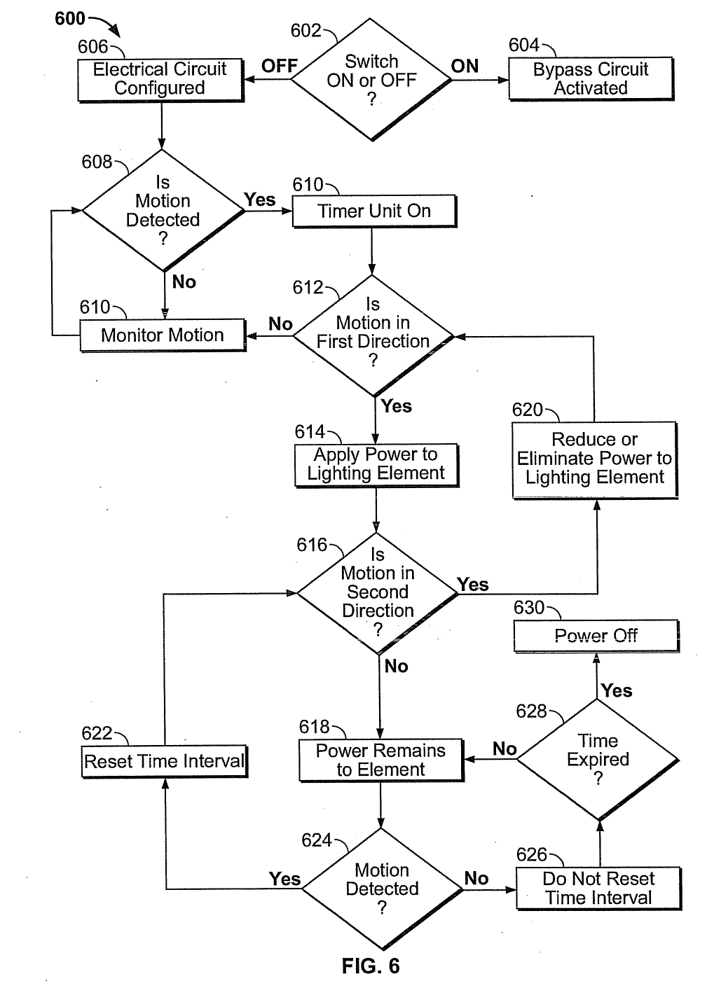

An exemplary operating method 600 of the motion-sensing light control circuit 500 or other suitable circuit is shown in FIG. 6. At 602, a manual bypass state is checked, if manual bypass is “ON,” the motion-sensing circuit may be bypassed and control of the lighting element accomplished using a manual or bypass circuit 604. If the manual bypass is “OFF,” the controller may be booted up and determine an initial system state at 606. Initially, the controller filters signals coming from the motion sensor until a motion used for directional signalling is detected, at 608. If no signaling motion is detected at 608, no action is taken other than condoning to monitor for initiation of a signaling motion at 610. If a signaling motion is detected, a timer may be initiated at 610.

At 612, a direction of signaling motion may be determined, or the current direction may he adopted as the lighted direction. At 614, the controller may apply power to the lighting element and monitor the signals from the motion sensor for an indication of motion reversal at 616. So long as data from the motion sensor indicates that motion of the light continues in the lighted direction, power may be supplied to the lighting element 618. However, if the motion does not reverse after a defined period of time, the controller may shut off or dim the lighting element at 620, optionally resetting a time interval 622 that may be used to define a maximum cycle length. If a motion reversal is detected and motion is in an unlighted direction 616, the controller may also shut off or dim the lighting element. An “unlighted direction” may he defined as a direction of movement generally opposite to a direction in which the flashlight is lit. The may then continue to monitor for a reversal to a lighted direction 612.

If no motion is detected, an inactivity-tracking interval is not reset 626. If the inactivity internal exceeds a defined threshold (for example, several minutes) 628, the circuit may power itself off 630 to preserve stored power. If time is not expired, the circuit remains powered up and motion monitoring 624 continues. If any motion is detected, the inactivity timer may be reset to zero 622.

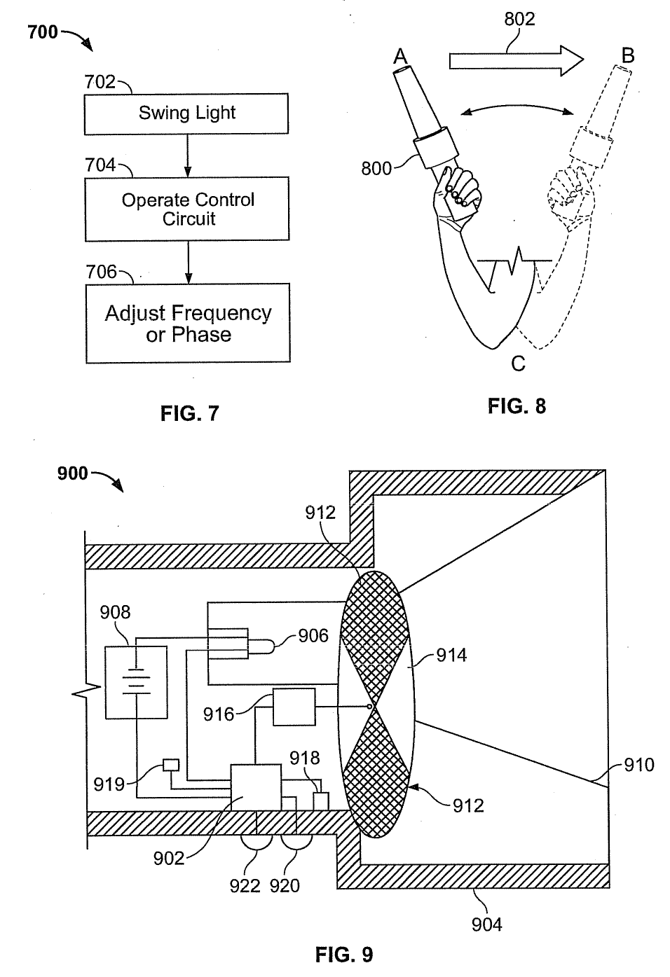

FIG. 7 shows exemplary steps of a method 700 for using a portable light with a motion-sensing light control circuit to signal a direction of movement, such as for signaling traffic. At step 702, a person holding the light may turn it on, activating a motion control circuit as described herein, and begin swinging the light side-to-side or back and forth. For example, as shown in FIG. 8, a light 800 may be swung back-and-forth between the positions ‘A’ and ‘B’ by a pivoting movement around point ‘C’ to signal a direction of movement, for example, a direction as indicated by the arrow 802 in FIG. 8. The action of swinging the light coupled with providing power to the control circuit may cause operation of a control circuit. The light therefore illuminates while being swung in a first direction and turns off or dims when moving generally opposite to the first direction.

A user of the signaling light may wish to adjust a frequency or phase of the signaling light, as indicated at step 706. A signaling light that is cut of phase will signal an incorrect direction. For example, referring to FIG. 8, if the light 800 is illuminated when moving from position ‘B’ to ‘A’, and turned off when moving from ‘A’ to ‘B’ a signal direction opposite to arrow 802 would be indicated. The light may therefore be 180° out of phase. The user may correct this by providing an appropriate input to the control circuit, such as by activating a control button or switch connected to the circuit. In response to such input, the control circuit may change the phase of the illumination cycle by 180°. Phase adjustments of other than 180°, for example, an adjustment of 90° or any other amount, may also be useful to correct signaling errors or provide special signal characteristics.

In some embodiments, the control circuit may control the frequency at which the signaling light blinks, independently of signals from a motion sensor. In these embodiments, a directional signal may be provided by swinging the light in phase with the signal frequency so that the light is on while moving in the intended signal direction and is off when returning in the opposite direction. Accordingly, for a frequency-controlled signaling light it may be desirable to adjust the signal frequency and thereby cause the signal light to blink more slowly., or more quickly, to match a frequency at which the light is swung. This may be accomplished via a suitable user interface device provided on an outer housing of the portable signaling light. In addition, it may be desirable to provide an adjustment for a ratio of time on to time off. For example, the signal light may be adjusted to be on 40% of the time and off 60% of the time, from a baseline 50/50 on/off ratio.

Instead of directly controlling a phase and frequency of a signaling light, a suitable control circuit may be used to control operation of a shutter mechanism that alternately blocks and transmits light. FIG. 9 shows an exemplary portion of a signaling light 900 using a shelter mechanism 912 to alternately block and transmit light from a lamp 906 to an exterior of a housing 904. Signaling light 900 includes an electrical circuit comprising a controller 902 operatively connected to a motion sensor 918, timer 919, power source 908 and control buttons 920, 922 disposed on an exterior of the signaling light. The control buttons and timers may be configured as described for other embodiments to provide user input and timing input to a control process, or to shut off the light 900 when not in use.

Controller 902 may also be connected to a motor driving operation of a mechanical shutter 912. Various types of mechanical shutters may be suitable for use with signaling light 900, for example, rotating shutters or choppers, vibrating blades, or single and multi-bladed shutters. An exemplary shutter may include, for example, a wheel comprising alternating opaque 912 and transparent 914 areas, which may be disposed and operated to alternately block and transmit light from a lamp 906 from being transmitted through a reflector 910 to an exterior of the housing 904. Shutter frequency may be controlled by controlling a rotational output speed of the motor 916. Phase adjustments may be made using position feedback and position control signals to a positioning motor, such as, for example, a stepper motor, servo motor, or any suitable electric motor. Use of a shutter-operated signaling system may as the same as disclosed for embodiments in which a light source is directly controlled. A shutter-operated system may provide the advantage of longer lamp life, but at the additional cost of a shutter mechanism with its motor and moving parts.

Having thus described embodiments of a signaling light with a motion sensor that illuminates the light when the signal light is swung in a first direction, then turns off or dims when swung in a different direction, it should be apparent to those skilled in the art that certain advantages of the foregoing signaling light have been achieved. It should also be appreciated that various modifications, adaptations, and alternative embodiments thereof may be made within the scope and spirit of the present invention.

What is claimed is:

1. A portable light comprising:
a housing configured for holding a lighting element and a portable power source; and
an electrical circuit coupled to the housing, the circuit configured for sensing motion of the housing and causing the lighting element to emit light in response to movement of the housing in a first direction and to switch off or dim in response to movement of the housing in a second direction opposite to the first direction.

2. The portable light of claim 1, further comprising a motion sensor coupled to the circuit, the motion sensor configured to provide an electrical signal indicating a direction of motion of the flashlight housing.

3. The portable light of claim 1, further comprising a shutter mechanism operatively connected to the electrical circuit and disposed to alternately cause the lighting element to emit light and to switch off or dim in response to signals from the electrical circuit.

4. The portable light of claim 3, wherein the shutter mechanism is configured to switch off the lighting element by blocking light from an illuminated lamp.

5. The portable light of claim 1, further comprising a lighting element coupled to the electrical circuit and housed in the flashlight housing.

6. The portable light of claim 5, wherein the lighting element comprises an element selected from the group consisting of: an LED lamp, an incandescent lamp, a laser, and an infrared lamp.

7. The portable light of claim 1, wherein an exterior of the housing is configured for being gripped by a human hand.

8. The portable light of claim 1, where the electrical circuit is further configured for switching off the lighting element after no motion of the housing is detected for a defined period of time.

9. The portable light of claim 1, further comprising an electrical power source coupled to the electrical circuit.

10. The portable light of claim 1, further comprising a user input device disposed to selectively deactivate a portion of the circuit for sensing motion.

11. The portable light of claim 1, wherein the housing is coupled to a diffusive cover configured for diffusing emitted light from the lighting element.

12. The portable light of claim 11, wherein the diffusive cover comprises a plastic material.

13. The portable light of claim 11, wherein the diffusive cover is colored.

14. A method of using a portable light as a signaling device indicating a signaled direction comprising:
alternatively moving a portable light in first direction and a second direction opposite to the first direction to indicate a signaled direction generally in the direction of the first direction; and
operating a circuit coupled to the portable light, the circuit operative to sense the first and second directions of movement of the portable light and to cause the portable light to emit light in response to movement of the housing in the first direction and to switch off or dim in response to movement of the housing in the second direction

15. The method of claim 14, further comprising swinging the portable light back-and-forth in the first and second directions.

16. The method of claim 14, further comprising operating the circuit to switch off the portable light when the portable light is moved in the second direction.

17. The method of claim 14, further comprising operating the circuit to dim the portable light when the portable light is moved in the second direction.

18. A circuit assembly for controlling light emitted from a portable light, the assembly comprising:
a substrate;
an electrical circuit coupled to the substrate and configured for causing a light connected to the electrical circuit to emit light in response to movement of the substrate in a first direction and to switch off or dim in response to movement of the substrate in a second direction opposite to the first direction.

19. The assembly of claim 18, further comprising a motion sensor coupled to the electrical circuit.

20. The assembly of claim 18, further comprising a timer coupled to the electrical circuit.

21. The assembly of claim 18, further comprising a controller device coupled to the electrical circuit.

22. The assembly of claim 21, further comprising a user input coupled to the controller device and configured for providing a manual override signal for bypassing normal operation of the controller.
